(19) United States
(12) Patent Application Publication
(10) Pub. No.: US 2023/0207979 A1
(43) Pub. Date: Jun. 29, 2023

(54) BATTERY

(71) Applicant: TOYOTA JIDOSHA KABUSHIKI KAISHA, Toyota-shi (JP)

(72) Inventor: Ryo KAGAMI, Ichinomiya-shi (JP)

(21) Appl. No.: 18/066,368

(22) Filed: Dec. 15, 2022

(30) Foreign Application Priority Data
Dec. 28, 2021 (JP) 2021-215157

(51) Int. Cl. H01M 50/533; H01M 50/528

(52) U.S. Cl. CPC H01M 50/533; H01M 50/528

(57) ABSTRACT

Provided is a battery that can improve structural reliability. The battery includes: a power generating element provided with plural current collector tabs aligning in a thickness direction; and a current collector terminal connected to the current collector tabs, wherein at least one of the current collector tabs has at least one slit by which an end portion of said at least one current collector tab is divided in a width direction, and portions into which the end portion of said at least one current collector tab is divided by said at least one slit therebetween are each electrically connected to another one of the current collector tabs that are adjacent to said at least one current collector tab in the thickness direction.

### FIELD

The present application relates to a battery.

### BACKGROUND

Patent Literature 1 discloses a method of joining a layered structure formed of layering a plurality of sheets of metal foil and a plurality of insulating films, and a metal plate put on an end of the layered structure to each other, the method comprising: the first step of alternately layering the sheets of the metal foil, on an end of each of which a cut is formed, and the insulating films, to make the layered structure; the second step of making the metal plate be brought into contact with an end portion of the layered structure where the cuts are formed, to bend the ends of the sheets of the metal foil, which are in contact with the metal plate, uniformly in the layering direction; and the third step of welding the ends of the sheets of the metal foil and the metal plate to each other in a state where the ends of the sheets of the metal foil, which are in contact with the metal plate, are bent uniformly in the layering direction.

Patent Literature 1 discloses that the following effect can be expected from the joining method disclosed therein. The ends of the sheets of the metal foil are bent by the metal plate in a predetermined direction. Further, a laser beam is moved in a direction in which the ends of the sheets of the metal foil are uniformly bent. This facilitates the extension of the ends of the sheets of the metal foil in that direction due to thermal expansion. Accompanied with this, the ends of the sheets of the metal foil are pressed against the metal plate due to a shock when the metal plate is molten even when the ends of the sheets of the metal foil are about to be separate from the metal plate. This makes it difficult for the ends of the sheets of the metal foil, and the metal plate to gap therebetween, so that the metal foil and the metal plate can be welded to each other with the result of stable welding with few welding defects. As a result, the welding strength between the metal foil and the metal plate can be ensured.

### CITATION LIST

### Patent Literature

Patent Literature 1: JP 2011-129328 A

### SUMMARY

### Technical Problem

Concerning a conventional battery, since the current collector tabs are each solely joined to the current collector terminals, electric power cannot be supplied from a part of the electrodes when welding defects are produced, which is problematic. This problem is significant when an electrode stack is used for a power generating element of this battery. Thus, batteries having such improved structural reliability that such a problem does not arise are demanded.

In view of the above-described circumstances, an object of the present disclosure is to provide a battery that can improve structural reliability.

### Solution to Problem

As one aspect to solve the above-described problem, the present disclosure is provided with a battery comprising: a power generating element provided with plural current collector tabs aligning in a thickness direction; and a current collector terminal connected to the current collector tabs, wherein at least one of the current collector tabs has at least one slit by which an end portion of said at least one current collector tab is divided in a width direction, and portions into which the end portion of said at least one current collector tab is divided by said at least one slit therebetween are each electrically connected to another one of the current collector tabs that are adjacent to said at least one current collector tab in the thickness direction.

In the battery, the portions may be electrically connected to other ones of the current collector tabs, the other ones being arranged at different positions, respectively, in the thickness direction. The current collector tabs may each have at least one slit by which an end portion of each of the current collector tabs is divided in the width direction, and portions into which the end portion of every one of the current collector tabs is divided by said at least one slit therebetween may be electrically connected to portions of end portions of any other ones of the current collector tabs, respectively, said any other ones being adjacent to said every one of the current collector tabs in the thickness direction. Further, the portions of the end portion of said every one of the current collector tabs may be electrically connected to the portions of the end portions of said any other ones of the current collector tabs, respectively, by bending the portions of said every and any other ones of the current collector tabs inward together to be in contact with each other.

### Advantageous Effects

In the battery according to the present disclosure, portions into which every current collector tab is divided by a slit therebetween, are each electrically connected to one of current collector tabs that are adjacent to said every current collector tab in the thickness direction. In this state, the current collector tabs are joined to a current collector terminal. Therefore, even if joining defects are produced on a part of the joined portions of these current collector tabs and current collector terminal, which are electrically connected to each other, these current collector tabs and current collector terminal are electrically connected to each other via any other joined portions. That is, electric power can be supplied from the power generating element, which has some current collector tab on which welding defects are produced, without electric isolation of the power generating element. Therefore, the battery according to the present disclosure can improve structural reliability.

### BRIEF DESCRIPTION OF DRAWINGS

FIG. 1A is a perspective view of a battery 100, and FIG. 1B is an exploded perspective view of the battery 100;

FIG. 2 is a schematic cross-sectional view taken along II-II of FIG. 1B;

FIG. 3 is a perspective view of anode current collector tabs 11b;

FIG. 4A is a front view when the anode current collector tabs 11b are observed from IVA of FIG. 3, FIG. 4B is a cross-sectional view taken along IVB-IVB of FIG. 3, and FIG. 4C is a cross-sectional view taken along IVC-IVC of FIG. 3;

FIGS. 5A and 5B are cross-sectional views corresponding to FIGS. 4B and 4C, respectively, when an anode current collector terminal 20b is joined to the anode current collector tabs 11b;

FIG. 6A is a front view according to another form of the anode current collector tabs 11b; FIG. 6B is a cross-sectional view taken along VIB-VIB of FIG. 6A; and FIG. 6C is a cross-sectional view taken along VIC-VIC of FIG. 6A;

FIG. 7A is a front view according to yet another form of the anode current collector tabs 11b; FIG. 7B is a cross-sectional view taken along VIIB-VIIB of FIG. 7A; and FIG. 7C is a cross-sectional view taken along VIIC-VIIC of FIG. 7A; and

FIG. 8 is a schematic view showing a way of each step of a battery production method according to one embodiment.

### DESCRIPTION OF EMBODIMENTS

### Battery

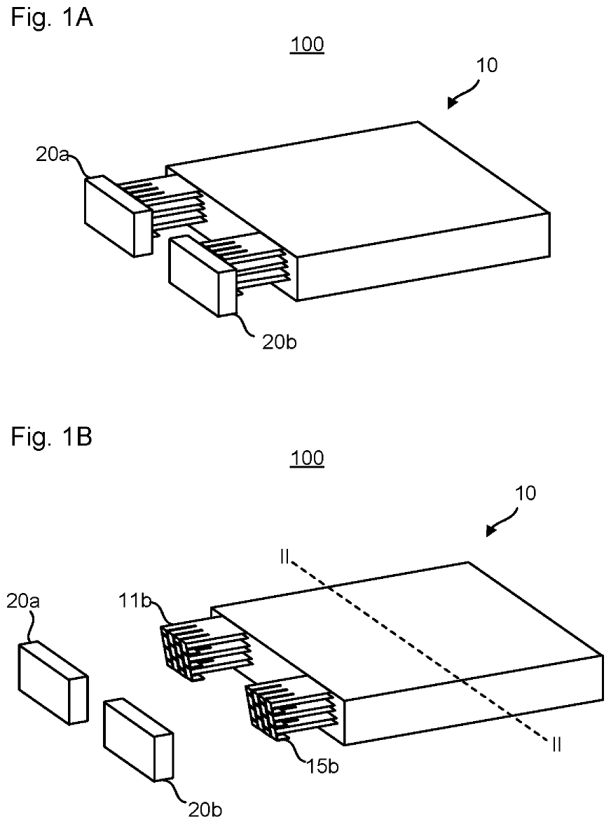

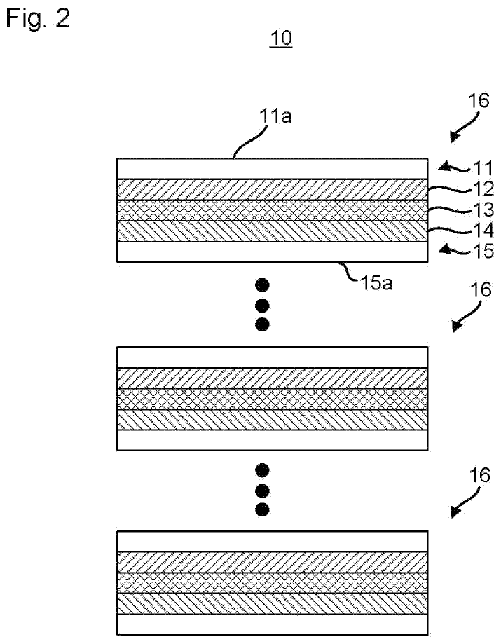

A battery according to the present disclosure will be described with reference to a battery 100 that is one embodiment. FIG. 1A is a perspective view of the battery 100, and FIG. 1B is an exploded perspective view of the battery 100. FIG. 2 is a schematic cross-sectional view taken along II-II of FIG. 1B.

As shown in FIGS. 1A and 1B, the battery 100 is provided with a power generating element 10 including plural current collector tabs (anode current collector tabs 11b and cathode current collector tabs 15b) aligning in the thickness direction, and current collector terminals (an anode current collector terminal 20a and a cathode current collector terminal 20b) joined to the current collector tabs. In FIGS. 1A and 1B, the current collector tabs are arranged on the same face of the power generating element 10, but are not limited to this. The current collector tabs may be arranged on different faces of the power generating element 10. The positions where the current collector terminals are placed are considered in the same manner as the current collector tabs.

<Power Generating Element 10>

The power generating element 10 is a power generating component for a battery. The power generating element 10 may be a stack formed by stacking electrodes, or a wound body formed by winding electrodes. The type of the power generating element 10 is not particularly limited. The power generating element 10 may be a power generating element for a solution-based battery, or for an all-solid-state battery. The shape of the power generating element 10 is not particularly limited. For example, the power generating element 10 may have a rectangular shape in a plan view. FIG. 1 shows, as an example, the battery 100 including the power generating element 10 that is a stack formed by stacking electrodes for all-solid-state batteries. Hereinafter the power generating element 10 that is a stack formed by stacking electrodes for all-solid-state batteries will be described. It is noted that the structure of the power generating element 10 is not limited to the following.

The power generating element 10 is provided with an anode current collector layer 11, an anode active material layer 12, a solid electrolyte layer 13, a cathode active material layer 14, and a cathode current collector layer 15 in this order in the thickness direction. The power generating element 10 may be provided with plural electrode bodies 16 in the thickness direction: each of the electrode bodies 16 is one repeating unit including the anode current collector layer 11, the anode active material layer 12, the solid electrolyte layer 13, the cathode active material layer 14, and the cathode current collector layer 15. The electrode bodies 16 may be stacked in series or in parallel. When the power generating element 10 is provided with the plural electrode bodies 16, adjacent electrode bodies 16 may share the cathode current collector layer 11 or the anode current collector layer 15. FIG. 1 shows the power generating element 10 provided with the plural electrode bodies 16.

(Anode Current Collector Layer 11)

The anode current collector layer 11 is made from metal foil in the form of a sheet. The anode current collector layer 11 is provided with an anode flat plate part 11a in contact with the anode active material layer 12, and the anode current collector tab 11b extending outward from the anode flat plate part 11a. The anode current collector tab 11b is a member for connecting the anode flat plate part 11a and the anode current collector terminal 20a. The anode flat plate part 11a and the anode current collector tab 11b may be formed of one member, or of different members. When the power generating element 10 has the plural electrode bodies 16, the anode current collector tabs 11b may be arranged so as to align straight in the thickness direction.

The anode current collector layer 11 may be formed from any metal without particular limitations. Examples of the metal here include Cu, Ni, Cr, Au, Pt, Ag, Al, Fe, Ti, Zn, Co, and stainless steel; and a preferred example thereof is Cu. The anode current collector layer 11 may have some coating (such as a carbon coating) on the surface thereof for adjusting the resistance. The anode current collector layer 11 may have a thickness of, for example, 0.1 μm to 1 mm.

(Anode Active Material Layer 12)

The anode active material layer is a layer in the form of a sheet, and containing an anode active material. The anode active material here is not particularly limited. Examples of this anode active material include silicon-based active materials such as Si, Si alloys, and silicon oxide; carbon-based active materials such as graphite and hard carbon; various oxide-based active materials such as lithium titanate; lithium metal; and lithium alloys.

The anode active material layer 12 may optionally contain a conductive additive, a binder, and/or a solid electrolyte. The conductive additive here is not particularly limited. Examples of this conductive additive include carbon materials such as acetylene black and Ketjenblack, and metallic materials such as nickel, aluminum, and stainless steel. The binder here is not particularly limited. Examples of this binder include butadiene rubber (BR), butyl rubber (IIR), acrylate-butadiene rubber (ABR), and polyvinylidene fluoride (PVdF). The solid electrolyte here is not particularly limited. For example, this solid electrolyte may be an organic polymer electrolyte or an inorganic solid electrolyte; and is preferably an inorganic solid electrolyte because the inorganic solid electrolyte has higher ion conductivity than, and superior heat resistance to the organic polymer electrolyte. The inorganic solid electrolyte here may be an oxide solid electrolyte or a sulfide solid electrolyte; and is preferably a sulfide solid electrolyte. Examples of the oxide solid electrolyte here include lithium lanthanum zirconate, LiPON, Li₁₊ₓAlₓGe₂₋ₓ(PO₄)₃, Li—SiO based glasses, and Li—Al—S—O based glasses. Examples of the sulfide solid electrolyte here include Li₂S—P₂S₅, Li₂S—SiS₂, LiI—Li₂S—SiS₂, LiI—Si₂S—P₂S₅, Li₂S—P₂S₅—LiI—LiBr, LiI—Li₂S—P₂S₅, LiI—Li₂S—P₂O₅, LiI—Li₃PO₄—P₂S₅, and Li₂S—P₂S₅—GeS₂.

The content of each component in the anode active material layer 12 may be appropriately set according to the purpose. The anode active material layer may have a thickness of, for example, 0.1 μm to 1 mm.

(Solid Electrolyte Layer 13)

The solid electrolyte layer 13 is a layer in the form of a sheet, and containing a solid electrolyte. The solid electrolyte here is not particularly limited. This solid electrolyte may be appropriately selected from the solid electrolytes that can be used for the anode active material layer.

The solid electrolyte layer 13 may optionally contain a binder. The binder here is not particularly limited. This binder may be appropriately selected from the binders that can be used for the anode active material layer.

The content of each component in the solid electrolyte layer 13 may be appropriately set according to the purpose. The solid electrolyte layer 13 may have a thickness of, for example, 0.1 μm to 1 mm.

(Cathode Active Material Layer 14)

The cathode active material layer 14 is a layer in the form of a sheet, and containing a cathode active material. The cathode active material here is not particularly limited. Examples of the cathode active material include various lithium-containing composite oxides such as lithium cobaltate, lithium nickelate, lithium manganate, lithium nickel cobalt oxide, lithium nickel cobalt manganese oxide, and spinel lithium compounds.

The cathode active material layer may optionally contain a conductive additive, a binder, and/or a solid electrolyte. The conductive additive, the binder, and the solid electrolyte here are not particularly limited. These conductive additive, binder, and solid electrolyte may be each appropriately selected from those usable for the anode active material layer.

The content of each component of the cathode active material layer 14 may be appropriately set according to the purpose. The surface of the cathode active material may be coated with an oxide layer such as a lithium niobate layer, a lithium titanate layer, and a lithium phosphate layer. The cathode active material layer 14 may have a thickness of, for example, 0.1 μm to 1 mm.

(Cathode Current Collector Layer 15)

The cathode current collector layer 15 is made from metal foil in the form of a sheet. The cathode current collector layer 15 is provided with a cathode flat plate part 15a in contact with the cathode active material layer 14, and the cathode current collector tab 15b extending outward from the cathode flat plate part 15a. The cathode current collector tab 15b is a member for connecting the cathode flat plate part 15a and the cathode current collector terminal 20b. The cathode flat plate part 15a and the cathode current collector tab 15b may be formed of one member, or of different members. When the power generating element 10 has the plural electrode bodies 16, the cathode current collector tabs 15b may be arranged so as to align straight in the thickness direction.

The cathode current collector layer 15 may be formed from any metal without particular limitations. Examples of the metal here include Cu, Ni, Cr, Au, Pt, Ag, Al, Fe, Ti, Zn, Co, and stainless steel; and a preferred example thereof is AI. The cathode current collector layer 15 may have some coating (such as a carbon coating) on the surface thereof for adjusting the resistance. The cathode current collector layer 15 may have a thickness of, for example, 0.1 μm to 1 mm.

(Forms of Current Collector Tabs)

The battery 100 has current collector tabs of a characteristic form. Hereinafter the characteristic form of the current collector tabs will be described particularly in terms of the anode current collector tabs 11b. This characteristic form of the current collector tabs may be also applied to the cathode current collector tabs 15b. Thus, the following description can be also applied to the depression on the cathode current collector tabs 15b.

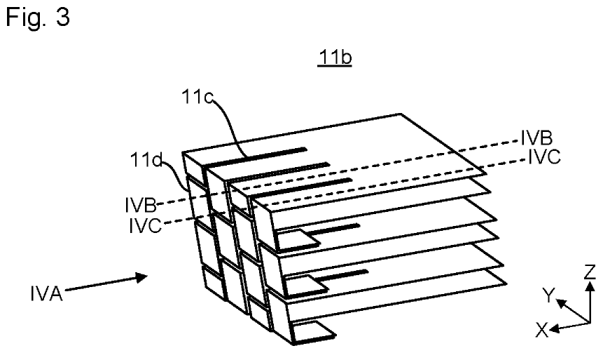

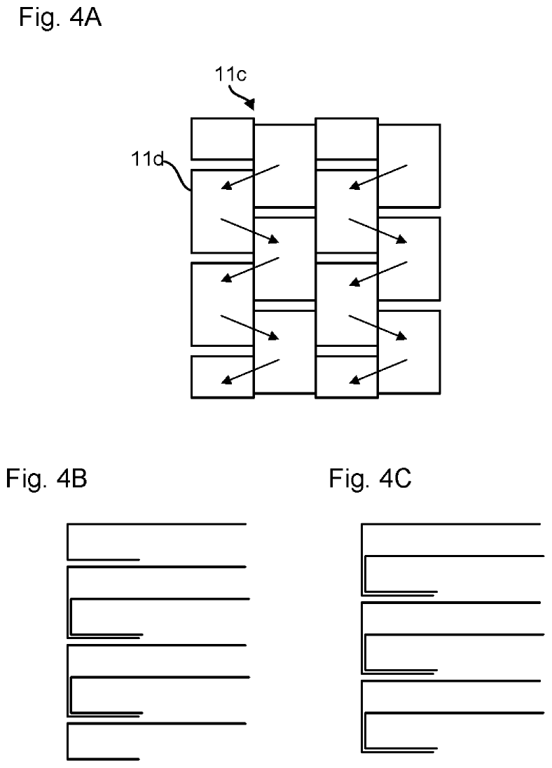

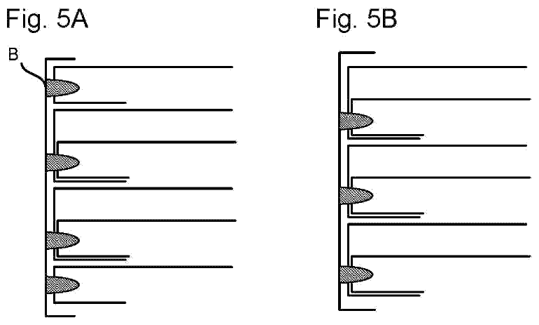

FIG. 3 is a perspective view of the anode current collector tabs 11b. FIG. 4A is a front view when the anode current collector tabs 11b are observed from IVA of FIG. 3, FIG. 4B is a cross-sectional view taken along IVB-IVB of FIG. 3, and FIG. 4C is a cross-sectional view taken along IVC-IVC of FIG. 3. FIGS. 5A and 5B are cross-sectional views corresponding to FIGS. 4B and 4C, respectively, when the anode current collector terminal 20b is joined to the anode current collector tabs 11b. Here, in FIG. 3, the extending direction (direction where the current collector tabs extend) is defined as the X direction; the width direction (the width direction of the current collector tabs) is defined as the Y direction; and the thickness direction (the thickness direction of the current collector tabs) is defined as the Z direction. These directions have an orthogonal relationship with one another.

As shown in FIGS. 3, and 4A to 4C, the plural anode current collector tabs 11b are arranged to align in the thickness direction. Each of the anode current collector tabs 11b has three slits 11c by which an end portion thereof (an outside end portion thereof in the extending direction) is divided in the width direction; thereby, the end portion of each of the anode current collector tabs 11b is divided into four portions 11d.

The portions 11d, into which the end portion of every anode current collector tab 11b is divided by the slits, are each electrically connected to the portions 11d, into which the end portion of one of anode current collector tabs 11b that are adjacent to said every anode current collector tab 11b in the thickness direction is divided by the slits. At this time, every two portions 11d, into which the end portion of every anode current collector tab 11b is divided by the slit therebetween, are electrically connected to other anode current collector tabs 11b that are arranged at different positions, respectively, in the thickness direction. The portions 11d of every anode current collector tab 11b are each connected to the portions 11d of other anode current collector tabs 11b that are adjacent to said every anode current collector tab 11b by bending the end portions (especially tip end portions) thereof together inward.

As described, the battery 100 has the anode current collector tabs 11b in the form of inwardly bending the end portions 11d. As indicated by the arrows in FIG. 4A, the anode current collector tabs 11b are each electrically connected. As shown in FIGS. 5A and 5B, the portions 11d of the anode current collector tabs 11b are each joined to the anode current collector terminal 20a. In FIGS. 5A and 5B, the jointed portions are indicated by B.

The battery 100 has the anode current collector tabs 11b of such a characteristic form; thereby, the anode current collector tabs 11b are each electrically connected. Therefore, even if joining defects are produced on a part of the joined portions of the anode current collector tabs 11b and the anode current collector terminal 20a, the anode current collector tabs 11b and the anode current collector terminal 20a are electrically connected to each other via the other joined portions. That is, electric power can be supplied from each of the electrode bodies 16 without electric isolation of some electrode body 16 having some anode current collector tab 11b on which welding defects are produced. Therefore, the battery 100 can improve structural reliability.

The shape of the slits 11c of the anode current collector tabs 11b is not particularly limited as long as allowing the end portions of the anode current collector tabs 11b to be divided by the slits 11c. In FIG. 3, the slits 11c are each a cut of a linear shape in the extending direction. The lengths of the slits 11c in the extending direction are not particularly limited as long as the portions 11d, into which every anode current collector tab 11b is divided by the slits 11c, can be connected to any other anode current collector tabs 11b that are adjacent to said every anode current collector tab 11b. The slits 11c may each have the same length as or different lengths from one another. The slits 11c of each of the anode current collector tabs 11b are not particularly limited in number as long as the number is at least one. FIG. 3 shows the anode current collector tabs 11b each having three slits 11c. The slits 11e of each of the anode current collector tabs 11b may be the same as or different from one another in number.

The way of electrically connecting every adjacent anode current collector tabs 11b in the thickness direction to each other is not particularly limited. In FIG. 3, the anode current collector tabs 11b are electrically connected by direct contact of the portions 11d thereof. For example, the anode current collector tabs 11b may be electrically connected via conductive members. The number of the portions 11d of each of the anode current collector tabs 11b to be electrically connected is not particularly limited. At least three portions 11d (particularly tip end portions) of each of the anode current collector tabs 11b may be bent together to be electrically connected. FIG. 3 shows the mode of every two portions 11d of the anode current collector tabs 11b which are bent together and electrically connected. In FIG. 3, every two portions 11d are inwardly bent together to be in contact with each other, and thereby, are electrically connected to each other. The connecting way of the portions 11d is not limited to this. For example, the portions may be just brought into contact with each other (or one another) without being bent. The direction in which every two (or three or more) portions 11d are bent together is not particularly limited either. The portions 11d may be bent toward either one or the other side in the thickness direction, or one and the other sides in combination in the thickness direction. Further, as shown in FIG. 3, there may be some anode current collector tabs 11b that are not connected to other anode current collector tabs 11b that are adjacent to said some anode current collector tabs 11b. In this case, the anode current collector tabs 11b that are not connected to the other anode current collector tabs 11b that are adjacent thereto may be also bent for easy connection with the anode current collector terminal 20a.

The way of joining the anode current collector tabs 11b and the anode current collector terminal 20a is not particularly limited, but any known way may be appropriately employed. Examples of this way include soldering, ultrasonic bonding, and laser welding. In FIGS. 5A and 5B, the places where the end portions 11d overlap are joined. The present disclosure is not limited to this. The number of the joining places is not particularly limited, either, as long as being at least one since, as described above, the inwardly bent anode current collector tabs 11b are each electrically connected.

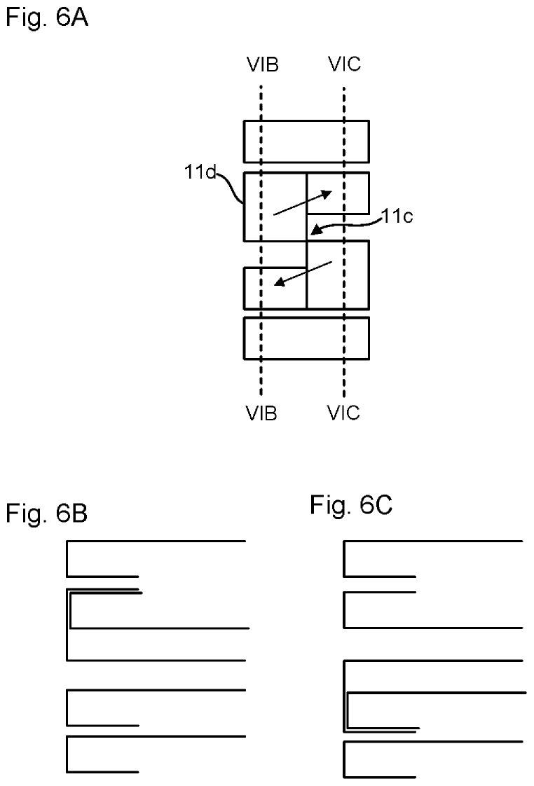

Next, another form of the anode current collector tab 11b will be described. In FIG. 3, the anode current collector tabs 11b each have the slits 11c. The battery according to the present disclosure is not limited to this as long as at least one anode current collector tabs 11b has (a) slit(s). For example, five anode current collector tabs 11b aligning in the thickness direction will be described: in these five anode current collector tabs 11b, only the third anode current collector tab 11b from the top has the slit 11c. FIG. 6A is a front view according to this form; FIG. 6B is a cross-sectional view taken along VIB-VIB of FIG. 6A; and FIG. 6C is a cross-sectional view taken along VIC-VIC of FIG. 6A.

As shown in FIGS. 6A to 6C, one of the portions 11d, into which the end portion of the third anode current collector tab 11b is divided by the slit 11e therebetween, is electrically connected to the other anode current collector tab 11b, which is above and adjacent to the third anode current collector tab 11b in the thickness direction. The other one of the portions 11d is electrically connected to the other anode current collector tab 11b, which is under and adjacent to the third anode current collector tab 11b in the thickness direction. As described, the portions 11d of the third anode current collector tab 11b, which has the slit 11c, are bent inward with the adjacent anode current collector tabs 11b, respectively; and as indicated by the arrows in FIG. 6A, the third anode current collector tab 11b having the slit 11c is electrically connected to the adjacent anode current collector tabs 11b via the portions 11d of the third and the adjacent anode current collector tabs 11b.

Therefore, even if joining defects are produced on a part of the joined portions of these anode current collector tabs 11b (a group of the anode current collector tabs) and anode current collector terminal 20a, a group of the anode current collector tabs 11b and the anode current collector terminal 20a are electrically connected via the other joined portion. That is, electric power can be supplied from all the electrode bodies 16 without electric isolation of some electrode body 16 having some anode current collector tab 11b to which welding defects are produced. Therefore, the battery 100 having the anode current collector tabs 11b in such a form can improve structural reliability.

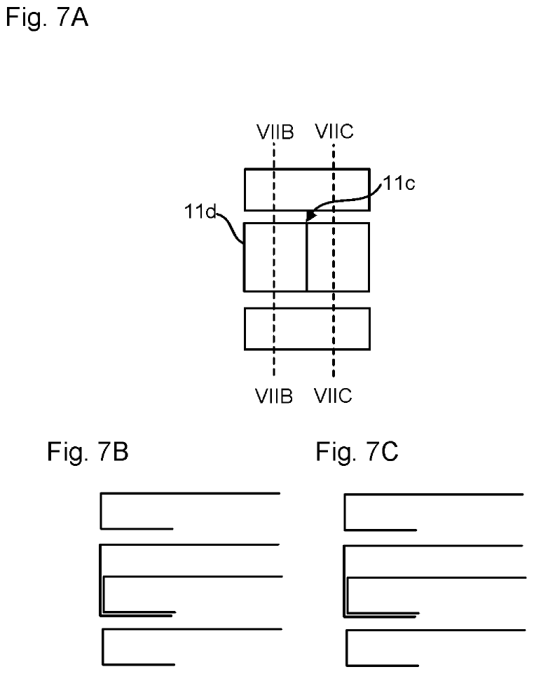

Yet another form of the anode current collector tab 11b will be described. In FIG. 3, every two portions 11d, into which the end portion of every anode current collector tab 11b is divided by the slit therebetween, are electrically connected to the portions 11d of the end portion of other anode current collector tabs 11b that are arranged at different positions, respectively, in the thickness direction. The battery according to the present disclosure is not limited to this. The portions 11d of each of the current collector tabs 11b may be electrically connected to another anode current collector tab 11b. For example, four anode current collector tabs 11b aligning in the thickness direction will be described: in these four anode current collector tabs 11b, the second and the third anode current collector tabs 11b from the top each have the slit 11c. FIG. 7A is a front view of this form; FIG. 7B is a cross-sectional view taken along VIIB-VIIB of FIG. 7A; and FIG. 7C is a cross-sectional view taken along VIIC-VIIC of FIG. 7A.

As shown in FIGS. 7A to 7C, the portions 11d, into which the end portion of the second anode current collector tab 11b is divided by the slit 11c, are electrically connected to the portions 11d of the end portion of the third anode current collector tab 11b, which is different from the second anode current collector tab 11b; and the portions 11d, into which the end portion of the third anode current collector tab 11b is divided by the slit 11c, are electrically connected to the portions 11d of the end portion of the second anode current collector tab 11b, which is different from the third anode current collector tab 11b. Therefore, even if joining defects are produced on a part of the joined portions of these anode current collector tabs 11b (a pair of the anode current collector tabs) and anode current collector terminal 20a, the pair of the anode current collector tabs 11b and the anode current collector terminal 20a are electrically connected via the other joined portions. That is, electric power can be supplied from all the electrode bodies 16 without electric isolation of some electrode body 16 having an anode current collector tab 11b on which welding defects are produced. Therefore, the battery 100 having the anode current collector tabs 11b in such a form can improve structural reliability. <Current Collector Terminals>

The current collector terminals are members for connecting the power generating element 10 and external members to each other. The anode current collector terminal 20a is connected to the anode current collector tabs 11b; and the cathode current collector terminal 20b is connected to the cathode current collector tabs 15b. The material of the terminals is not particularly limited, but may be appropriately selected from the metallic materials that can be used for the anode current collector terminal 20a or the cathode current collector terminal 20b.

<Other Member>

The battery 100 may be housed in an exterior body. The type of this exterior body is not particularly limited. Examples of the exterior body include a metal laminate such as an Al laminate, and a metal housing such as a metal can.

### Battery Production Method

Next, a production method for the battery according to the present disclosure will be described. The production method for the battery according to the present disclosure is not particularly limited. The battery may be produced by a known method. Hereinafter one embodiment of the production method for the battery provided with the power generating element that is a stack formed by stacking electrodes for all solid-state batteries will be described.

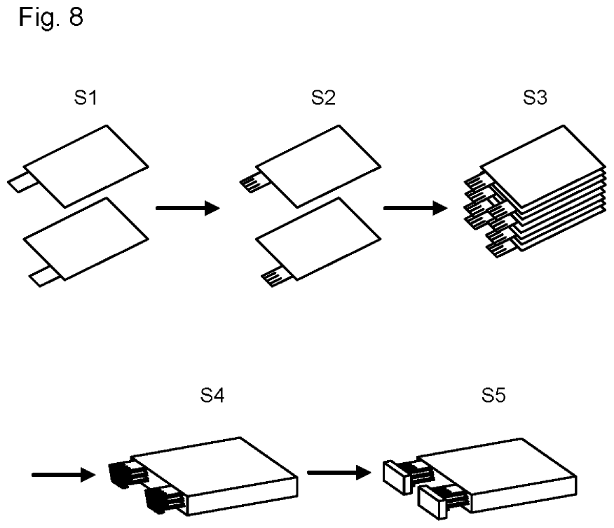

A battery production method according to the one embodiment includes an electrodes preparation step S1, a slit addition step S2, an electrodes stacking step S3, a current collector tab inwardly bending step S4, and a current collector terminals joining step S5. FIG. 8 is a schematic view of each of the steps.

<Electrodes Preparation Step S1>

The electrodes preparation step S1 is a step of preparing anode and cathode electrodes. The anode and cathode electrodes can be prepared by a known method. For example, the anode electrode can be obtained by: dispersing a material that is to constitute an anode active material layer in an organic solvent; and applying the obtained slurry to an anode current collector layer and drying the resultant. The cathode electrode can be obtained using the same method.

A solid electrolyte layer may be prepared by stacking on either one of the anode and cathode electrodes, or may be prepared separately from these electrodes. For example, one may stack the solid electrolyte layer on the anode electrode by dispersing a material that is to constitute the solid electrolyte layer in an organic solvent, applying the resultant to a surface of the anode active material layer of the anode electrode, and drying the resultant. Alternatively, one may prepare the solid electrolyte layer separately, and arrange the prepared solid electrolyte layer between the cathode and anode electrodes in the electrodes stacking step S3.

Here, electrode layers may be formed on both the faces of the anode and cathode electrodes that are to be used inside the stack.

<Slit Addition Step S2>

The slit addition step S2 is a step of adding (a) slit(s) to (a) current collector tab(s). A known method may be appropriately employed for the slit addition method. For example, it is enough that the current collector tab(s) is/are cut so as to have (a) slit(s).

<Electrodes Stacking Step S3>

The electrodes stacking step S3 is a step of stacking the anode and cathode electrodes to prepare the stack. The method of stacking each electrode is not particularly limited, but a known method may be appropriately employed. After prepared, the stack may be pressurized to enhance the adhesiveness of each electrode.

<Current Collector Tab Inwardly Bending Step S4>

The current collector tab inwardly bending step S4 is a step of inwardly bending portions into which (an) end portion(s) of the current collector tab(s) is/are divided by the slit(s). The inwardly bending step S4 may be carried out at the same time as the electrodes stacking step S3. That is, the current collector tab(s) may be inwardly bent as the anode and cathode electrodes are stacked.

<Current Collector Terminals Joining Step S5>

The current collector terminals joining step S5 is a step of joining the inwardly bent current collector tab(s) and the current collector terminals, respectively. The joining way is not particularly limited. Examples of the joining way include laser welding, ultrasonic bonding, and soldering.

### Reference Signs List

10 power generating element
11 anode current collector layer
11a anode flat plate part
11b anode current collector tab
11c slit
11d portion
12 anode active material layer
13 solid electrolyte layer
14 cathode active material layer
15 cathode current collector layer
15a cathode flat plate part
15b cathode current collector tab
16 electrode body
20a anode current collector terminal
20b cathode current collector terminal
100 battery

What is claimed is:

1. A battery comprising:
a power generating element provided with plural current collector tabs aligning in a thickness direction; and
a current collector terminal connected to the current collector tabs, wherein
at least one of the current collector tabs has at least one slit by which an end portion of said at least one current collector tab is divided in a width direction, and
portions into which the end portion of said at least one current collector tab is divided by said at least one slit therebetween are each electrically connected to another one of the current collector tabs that are adjacent to said at least one current collector tab in the thickness direction.

2. The battery according to claim 1, wherein
the portions are electrically connected to other ones of the current collector tabs, the other ones being arranged at different positions, respectively, in the thickness direction.

3. The battery according to claim 1, wherein
the current collector tabs each have at least one slit by which an end portion of each of the current collector tabs is divided in the width direction, and
portions into which the end portion of every one of the current collector tabs is divided by said at least one slit therebetween are electrically connected to portions of end portions of any other ones of the current collector tabs, respectively, said any other ones being adjacent to said every one of the current collector tabs in the thickness direction.

4. The battery according to claim 3, wherein
the portions of the end portion of said every one of the current collector tabs are electrically connected to the portions of the end portions of said any other ones of the current collector tabs, respectively, by bending the portions of said every and any other ones of the current collector tabs inward together to be in contact with each other.
